(19) United States
(12) Patent Application Publication
(10) Pub. No.: US 2018/0243891 A1
(43) Pub. Date: Aug. 30, 2018

(54) FUEL GAS-FIRED DRIVING-IN TOOL WITH CHARGING FUNCTION

(71) Applicant: Hilti Aktiengesellschaft, Schaan (LI)

(72) Inventors: Tilo DITTRICH, Feldkrich (AT); Norbert HEEB, Buchs (CH); Peter BRUGGMUELLER, Bludesch (AT); Thomas SPERRFECHTER, Grüsch (CH); Dominik SCHMIDT, Buchs (CH)

(21) Appl. No.: 15/758,000

(22) PCT Filed: Sep. 6, 2016
(86) PCT No.: PCT/EP2016/070951

§ 371 Date: Mar. 7, 2018

(30) Foreign Application Priority Data
Sep. 14, 2015 (EP) 15185079.9
Dec. 22, 2015 (EP) 15201878.4

(51) Int. Cl. B25C 1/08

(52) U.S. Cl. CPC B25C 1/08; B25C 1/008

(57) ABSTRACT

The invention relates to a driving-in tool, comprising a driving-in piston, guided in a cylinder, for driving a nail element into a workpiece, and a combustion chamber which is arranged at the driving-in piston and can be filled with an ignitable fuel-gas mixture. A positive pressure of the fuel-gas mixture in the combustion chamber can be generated particularly by means of a charging element. The combustion chamber comprises at least a first sub-housing and a second sub-housing that can be moved in an axial direction relative to the first sub-housing, the two sub-housings being sealed from each other by means of at least one first seal. A contact force can be applied to the seal in the axial direction, said contact force increasing monotonically with the positive pressure in the combustion chamber.

The invention relates to a nail gun, in particular to a manually controlled nail gun according to the preamble of claim 1.

EP 1 995 022 A1 describes a chargeable nail gun in which a combustion chamber comprises a first combustion chamber portion secured to the housing and a second combustion chamber portion that is slidable in a sleeve-like manner. The combustion chamber portions are sealed together in a closed position by means of radially acting O-rings.

It is the problem of the invention to provide a nail gun that permits a high charging pressure of the combustion chamber.

By providing a seal that may be acted upon by a pressure force in the axial direction, wherein the pressure force rises monotonically with the positive pressure in the combustion chamber, a basically improved seal is enabled. In particular, through the rise in the pressure force, a self-reinforcing seal of the combustion chamber is achieved. In addition, through such a seal arrangement, the friction between the seal and the movable sub-housing is reduced. An aging-induced material status of the seal therefore has at most a secondary influence on the seal.

Herein each element forming a wall section of the closed combustion chamber, apart from the driving piston itself, is understood to be sub-housing of the combustion chamber. In many structural types of nail guns, the relative motion of such sub-housings is used to close and/or clamp the combustion chamber, wherein the motion is coupled with safety mechanisms, which require correct mounting of the device on a workpiece. Usually the first sub-housing here comprises elements that are fixed in place relative to a device housing, wherein the second sub-housing is axially slidable with respect to the first sub-housing. Generally preferably, the axial direction is identical to a piston axis of the driving piston, wherein the mechanical structure is generally simplified.

A monotonic rise in the compression force with the positive pressure is understood to mean that at least over a region of an operational positive pressure of the combustion chamber, a rise in the force acting on the seal in the axial direction occurs at the same time.

A positive pressure of the combustible gas mix within the meaning of the invention is understood to mean an increased pressure for raising the driving energy. Even with conventional uncharged devices, the pressure of the combustible gas mix is usually somewhat above an ambient pressure, as the combustible gas under pressure is added to the air in the combustion chamber, which is under atmospheric pressure. This is only a slight pressure increase. A positive pressure within the meaning of the invention is preferably at least 100 mbar, especially preferably at least 200 mbar over the atmospheric pressure.

An axial load on the seal within the meaning of the invention is understood as an application of force on the seal by a sealing surface, whose force component in the axial direction is at least the same size or greater than a perpendicular, radially directed force component. Preferable, the axial force component is at least twice as greater, especially preferable at least three times as greater as the radial component.

Generally preferably, but not necessarily, the seal is made of a polymer, preferably an elastomer. The preferred elastomer can be, for example, a natural rubber, a silicone rubber, a fluorinated rubber, or some other fluorinated elastomer. Such seals have a great sealing effect with good tolerance or contamination or aging of the sealing surfaces. Generally preferably, the axially charged seal is configured as a closed O ring.

In a general advantageous further embodiment, the sub-housings have a stop in their relative motion, wherein a sealed state of the sub-housings over the length of a seal path is achieved before reaching the top. A seal path is understood to be the distance in the axial direction between the start of the sealing effect and a mechanically defined end or the stop of motion. This allows reliable sealing also with regarding to thermally or otherwise induced length alterations or tolerances. In a preferred detailed design, the seal path is at least 0.2 mm, especially preferably at least 0.4 mm. Especially preferably, the seal path is between 0.2 mm and 1.5 mm.

In a simple manner, such a seal path can be achieved in that the seal over the entire seal path is reversibly deformed. In alternative or supplementary embodiments, so as to achieve the defined seal path, it can also be provided that a wall portion of one of the sub-housings be elastically deformable or serve as a stop.

In a first embodiment of the invention it is provided that the second sub-housing forms a sleeve that is slidable in the axial direction, wherein the first seal engages a first end of the sleeve, and a second seal engages a second end of the sleeve. This allows an extensive opening of the combustion chamber by simple displacement of the second sub-housing. Preferably it is hereby provided that the positive pressure of the sleeve with regard to the first seal presses in the closing direction and with regard to the second seal presses in the opposite, opening direction, wherein a resultant total force acts in the closing direction. This can be achieved, for example, in that the first seal encloses a larger surface in the axial projection than the second seal.

In a second embodiment of the invention, the second sub-housing forms a combustion chamber base that is displaceable in the axial direction. Due to this design, the combustion chamber can form a variable but closed volume when the sub-housings are displaced.

Generally advantageously it can be provided that the sub-housings in addition can be sealed to one another via a radial seal acting perpendicularly to the axial direction.

The radial seal hereby allows a displacement of the sub-housings with respect to one another, without sealing being completely eliminated. In a preferred further embodiment it is provided that the radial seal forms a seal of the combustion chamber during a thermal recovery process of the driving piston. This allows a simple design of the device with respect to a piston return guide. Here the hot reaction products of the combustion gases after the driving action cool down in the closes volume of the combustion chamber, which leads to a negative pressure and a corresponding restoring force. The radial seal is hereby exposed to only relatively low pressure differences, while the first seal can be without engagement with the sub-housings.

Further advantages and features of the invention follow from the exemplary embodiments described below, as well as form the dependent claims.

Below several preferred exemplary embodiments of the invention are described and explained with reference to the attached drawings.

FIG. 1 shows a schematic sectional view of a nail gun according to a first exemplary embodiment of the invention in status with opened combustion chamber.

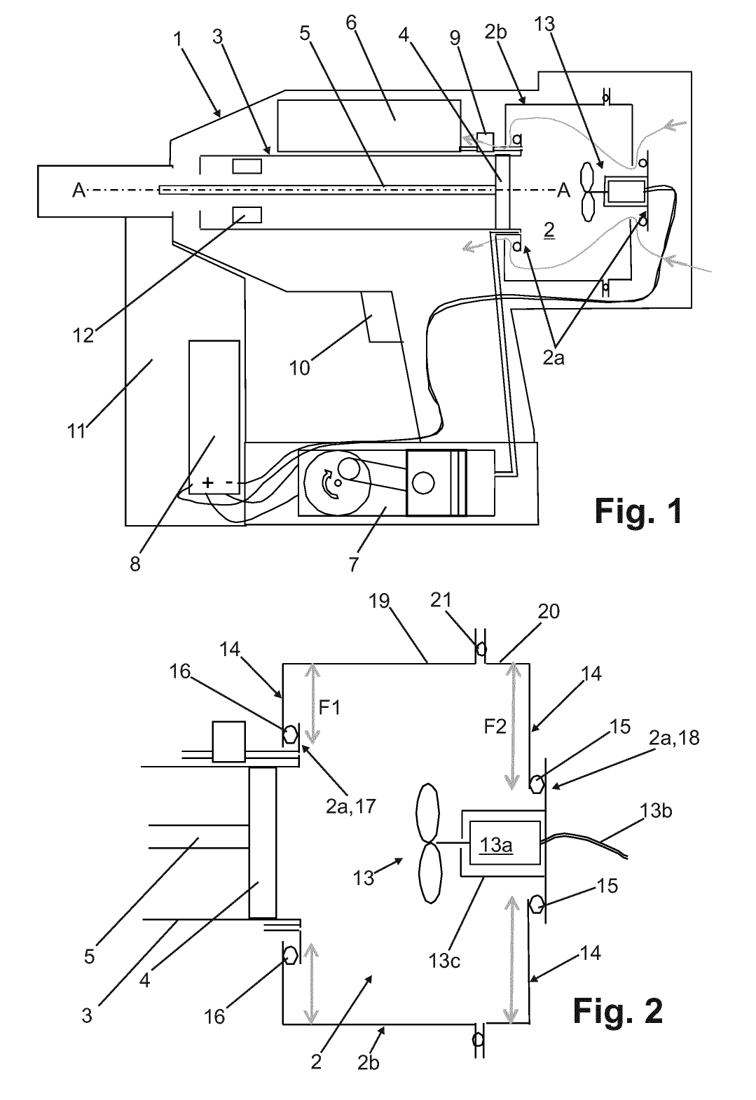

FIG. 2 shows a detailed view of the combustion chamber of the nail gun from FIG. 1 in closed state.

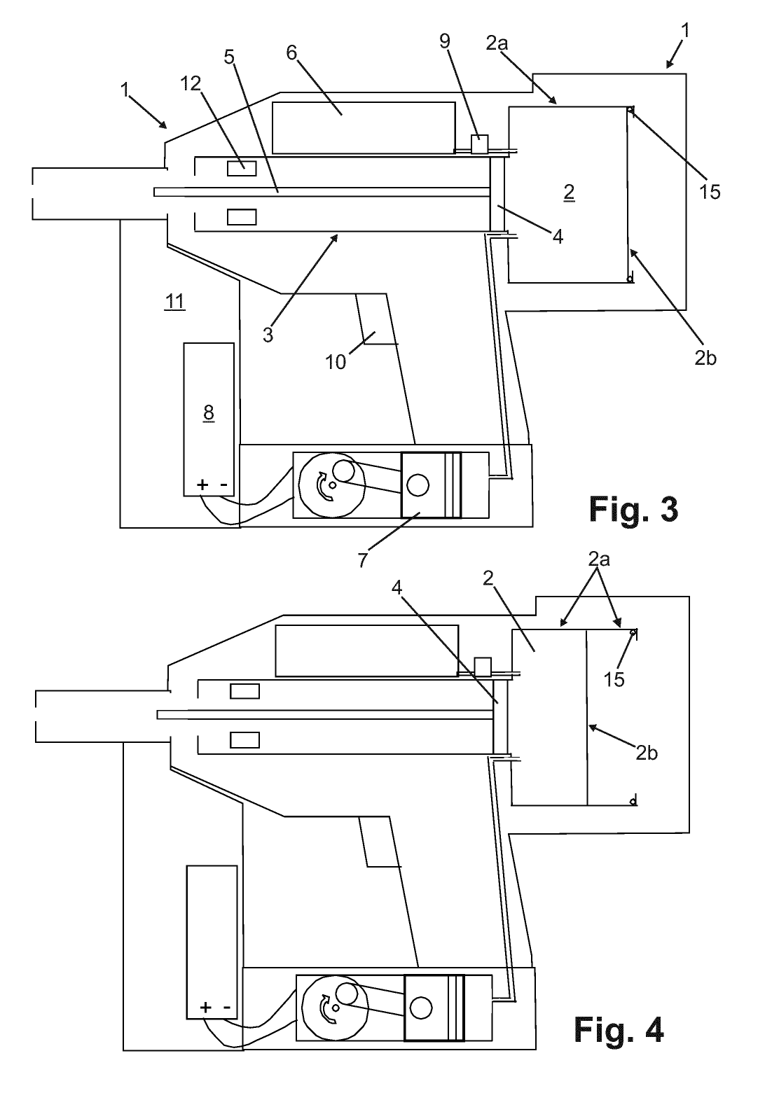

FIG. 3 shows a schematic sectional view of a nail gun according to a second exemplary embodiment of the invention in a state with charged combustion chamber.

FIG. 4 shows the nail gun from FIG. 2 with partially collapsed combustion chamber.

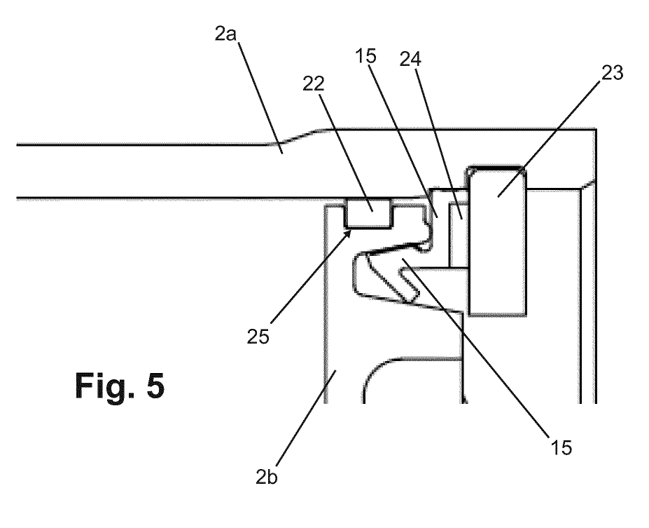

FIG. 5 shows a sectional view of a detailed design of a combustion chamber of a nail gun from FIG. 3.

The nail gun from FIG. 1 is a manually controlled device comprising a housing 1 and a combustion chamber 2 contained therein. A cylinder 3 lies adjacent to the combustion chamber 2 having a driving piston guided therein. The driving piston 4 comprises a driver member 5 for driving a nail element (not shown) into a workpiece (not shown).

An ignitable combustible gas mix is herein fed by means of a combustible gas container 6 into the combustion chamber 2. The combustible gas mix is then compressed by means of a charging element 7 to a positive pressure. The charging element is designed as an electrically driven compressor supplied via a battery 8, the compressor being arranged as an integral component of the nail gun within the housing 1. In further embodiments, the charging element is a device separated from the nail gun. In other embodiments, charging can also be carried out in particular by means of combustion-driven return of the driving piston 4 or in some other way.

The combustible gas is fed via a dispensing valve 9 from the combustible gas container 6 into the air of the combustion chamber 2. The combustible gas injection depending on requirements can be made as needed into the still non-compressed, partially compressed, or even fully compressed air.

In fully returned state (see FIG. 1) the driving piston 4 is held by a piston holder (not shown) against the positive pressure in the combustion chamber.

When the combustion chamber is charged, via a manually actuated trigger 10, the ignition of the combustible gas mix can be implemented by means of a spark plug, so that the driving piston 4 is driven forward, and via the driver member 5 the nail element (not shown) is driven out of a magazine 11 into the workpiece. The exhaust gases of the ignited and expanded combustible gas can enter the ambient space at the end of the path of the driving piston over the outlet openings 12.

In the combustion chamber 2 an electric fan 13 is arranged which is used for better mixing of the combustible gas and/or effective flushing of the combustion chamber. Herein the entire fan with drive motor 13a is positioned inside the combustion chamber, so that the electrical lines 13b are guided to the outside via a pressure-tight passage. The drive motor 13a is received in an additional protective housing 13c within the combustion chamber, in which in particular steam material can be provided to protect the motor against high accelerations. The combustion chamber 2 in ignitable state is to be understood as a closed room whose wall is formed by several parts or sections. One of the sections is formed by the nail gun 4, which is accelerated in the direction of a piston axis A after ignition.

A further section is formed by a first sub-housing 2a of the combustion chamber 2, which comprises elements are fixedly positioned with respect to the housing 1.

A second sub-housing 2b of the combustion chamber 2 is configured as a movable sleeve opposite the first sub-housing 2a. The second sub-housing 2b is herein slidable only linearly and axially in the direction of the piston axis A.

The sleeve 2a comprises collars 14 protruding radially toward the axially opposite ends, on which collars sealing surfaces are formed for lying on the first seal 15 and the second seal 16.

The seals 15, 16 are herein received each on one first radially extended wall section 17 and on a second radially extended wall section 18 of the first sub-housing 2a. Alternatively, each of the seals can also be received on the movable second sub-housing. The seals 15, 16 consist of an elastomer and are configured as O-rings.

If the second sub-housing is displaced in the closing direction (direction to the right in FIG. 1 and FIG. 2), the sealing surfaces of the sub-housings 2a, 2b in the axial direction lie against the seals 15, 16. Accordingly, a compression force acts in the axial direction on the seals 15, 16.

A positive pressure in the combustion chamber acts in the closed position of the second sub-housing on the one seal 15 in the opening direction and on the other seal 16 in the closing direction. Here the axial projections of the surfaces F1, F2, which are enclosed by seals 15, 16, vary in size. The surface F2 of the first seal 15, which is charged by the positive pressure in the closing direction of the sleeve, is markedly larger than the surface F1 of the second seal 16, which is uncharged by the positive pressure in the opening direction of the sleeve.

In the sum of the engaging pressure forces therefore, due to the positive pressure, a compression force results in the closing direction of the second sub-housing 2b. With an increase in the positive pressure, therefore, there is a rise in the compression forces to that of the seals 15, 16. The forces directly acting on the seals 15, 16 therefore increase with a pressure increase until the second sub-housing lies against a stop (not shown) opposite the first sub-housing.

The power increase occurs proceeding from a first sealing position of the second sub-housing over a defined seal path during continuously increase deformation toward one another of the elastic seals 15, 16 until the stop of the second sub-housing is reached. The seal path preferably is between around 0.4 and 1.5 mm each depending on aging status and elasticity of the seals 15, 16. With allowance for dimension and material of the seals 15, 16, a minimal seal path is ensure, which is greater than the occurring structural tolerances and thermally induced length changes of the sub-housings 2a, 2b.

The second sub-housing 2b is herein composed of two housing halves 19, 20, which for their part are sealed against one another by means of an O-ring 21. This design of the second sub-housing 2b allows simple installation and maintenance of the nail gun.

When the combustion chamber 2 is closed and charged, if the driving process is interrupted and ignition does not occur, the positive pressure can be released in a controlled manner by means of a valve element (not shown) until the second sub-housing 2b can be moved again without power.

It is understood that the second sub-housing 2b can be combined with known safety mechanisms (not shown), so that only a controlled mounting of the nail gun on a workpiece leads to a displacement of the second sub-housing and to a corresponding closing of the combustion chamber volume.

The second exemplary embodiment shown in FIG. 3 to FIG. 5 is a collapsing combustion chamber. The first sub-housing 2a of the combustion chamber fixedly arranged on the housing 1 of the nail gun is basically configured as a hollow cylinder. A base displaceable in the direction of the piston axis forms the second sub-housing 2b within the meaning of the invention. Accordingly, in this embodiment only an individual, axially charged O-ring 15 is required so as to ensure a reliable seal.

In a tensioned position of the combustion chamber 2, the base 2b lies against the seal 15 in the axial direction. With increasing positive pressure, the base 2b is pressed against the seal 15 with rising compression force. Here also, analogously to the previous example, a stop can be configured, and a defined seal path can be provided by means of elastic deformability of the seal 15.

With the position of the base 2b according to FIG. 2, a collapsed state of the combustion chamber 2 exists, in which no ignition of the combustion chamber can take place. In this state, the base 2b is disengaged from the first seal 15.

In the collapsed state nonetheless a seal of the base 2b against the first sub-housing 2a can be desired, so as to allow a thermal return position of the driving piston. With such a return position, the hot gases after ignition initially decrease via the outlet opening 12 to normal pressure, wherein the piston in recoil runs over the openings 12 and again closes the volume in the cylinder and combustion chamber 2. Following cooling, a negative pressure now ensues in the closed volumes, by which the piston is drawn in the direction of the initial position. In order to seal this volume against the base 2, on the base a further radial seal 22 (FIG. 5) is provided, which slides on the inner wall of the first sub-housing 2a.

FIG. 5 shows a possible structural detailed design of the base 2b with the seals 15, 22. Here the first axially charged seal is secured by means of a safety ring 23 and a supporting ring 24 on the inner circumference of the first sub-housing 2a. The base or the movable part pushes on the second sub-housing 2b with a bulge-shaped projecting sealing surface against the elastic seal 15.

The radial seal 22 is inserted in a peripheral circumferential groove 25 of the base 2b and slides on the inner wall of the first sub-housing 2a. Since the radial seal must seal off the pressure conditions only short periods of time in each case, it can be made of a hard or relatively inelastic sealing material.

It is understood that even in the case of the second exemplary embodiment, the movable sub-housing 2b preferably is coupled with safety mechanisms of the nail gun.

1. A nail gun for driving a nail element into a workpiece comprising
a driving piston guided in a cylinder;
a combustion chamber, which may be filled with an ignitable combustible gas mix such that the ignitable combustion gas mix is arranged on the driving piston;
and, a charging element, arranged to compress the combustible gas mix in the combustion chamber to a positive pressure;
wherein the combustion chamber comprises a first sub-housing, and a second sub-housing that is movable in an axial direction relative to the first sub-housing, and
wherein the first sub-housing and the second sub-housing are sealed against one another by at least one first seal,
wherein,
the at least one first seal may be acted upon with a compression force in the axial direction, wherein the compression force rises monotonically with the positive pressure in the combustion chamber.

2. The nail gun according to claim 1, wherein the first sub-housing and the second sub-housing have a stop in their relative motion, wherein a sealed state of the first sub-housing and the second sub-housing exists over the length of a seal path before reaching the stop.

3. The nail gun according to claim 2, wherein the seal path is at least 0.2 mm.

4. The nail gun according to claim 2, wherein the seal is reversibly deformed over an entire seal path.

5. The nail gun according to claim 1, wherein the second sub-housing forms a sleeve displaceable in the axial direction, wherein the at least one first seal engages a first end of the sleeve and a second seal engages a second end of the sleeve.

6. The nail gun according to claim 5, wherein the compression force with respect to the at least one first seal presses in a closing direction and with respect to the second seal presses in an opposite opening direction, wherein a resultant total force acts in the closing direction.

7. The nail gun according to claim 1, wherein the second sub-housing forms a base of the combustion chamber displaceable in the axial direction.

8. The nail gun according to claim 1, wherein the first sub-housing and the second sub-housing are additionally sealed against one another via a radial seal acting perpendicularly to the axial direction.

9. The nail gun according to claim 8, wherein the radial seal forms a seal of the combustion chamber during a thermal return process of the driving piston.

10. The nail gun according to claim 3, wherein the seal path is at least 0.4 mm.

11. The nail gun according to claim 3, wherein the seal is reversibly deformed over an entire seal path.

12. The nail gun according to claim 2, wherein the second sub-housing forms a sleeve displaceable in the axial direction, wherein the at least one first seal engages a first end of the sleeve and a second seal engages a second end of the sleeve.

13. The nail gun according to claim 3, wherein the second sub-housing forms a sleeve displaceable in the axial direction, wherein the at least one first seal engages a first end of the sleeve and a second seal engages a second end of the sleeve.

14. The nail gun according to claim 4, wherein the second sub-housing forms a sleeve displaceable in the axial direction, wherein the at least one first seal engages a first end of the sleeve and a second seal engages a second end of the sleeve.

15. The nail gun according to claim 2, wherein the second sub-housing forms a base of the combustion chamber displaceable in the axial direction.

16. The nail gun according to claim 3, wherein the second sub-housing forms a base of the combustion chamber displaceable in the axial direction.

17. The nail gun according to claim 4, wherein the second sub-housing forms a base of the combustion chamber displaceable in the axial direction.

18. The nail gun according to claim 2, wherein the first sub-housing and the second sub-housing are additionally sealed against one another via a radial seal acting perpendicularly to the axial direction.

19. The nail gun according to claim 3, wherein the first sub-housing and the second sub-housing are additionally sealed against one another via a radial seal acting perpendicularly to the axial direction.

20. The nail gun according to claim 4, wherein the first sub-housing and the second sub-housing are additionally sealed against one another via a radial seal acting perpendicularly to the axial direction.
